(19) United States
(12) Patent Application Publication
(10) Pub. No.: US 2004/0165205 A1
(43) Pub. Date: Aug. 26, 2004

(54) Image processing apparatus

(75) Inventor: Tomohide Oka, Shizuoka-ken (JP)

Correspondence Address: FOLEY AND LARDNER, SUITE 500, 3000 K STREET NW, WASHINGTON, DC, 20007, US

(73) Assignee: Toshiba Tec Kabushiki Kaisha

(21) Appl. No.: 10/368,457

(22) Filed: Feb. 20, 2003

(51) Int. Cl. G06F 3/12; G06F 15/00; H04N 1/00; G06F 13/00; G06F 11/30

(52) U.S. Cl. 358/1.13; 358/1.15; 358/401; 358/1.14; 358/1.16; 710/15

(57) ABSTRACT

An image processing apparatus receives print data from a print data source through a connection section connected to a network, interprets the language of the received print data and develops the data, and creates a first image data from the developed print data. The apparatus reads an image from a document to be copied, and creates a second image data. The apparatus compresses and temporarily stores at least one of the first and second image data. The apparatus transfers the stored compressed data to an image forming unit connected to the network.

### BACKGROUND OF THE INVENTION

1. Field of the Invention

The present invention relates to an image processing apparatus, which obtains information necessary to disperse the load from another image forming apparatus connected to a network, and disperses the load based on the obtained information.

2. Description of the Related Art

In recent years, many offices build up a system in which a plurality of computers (PC) and multifunction peripherals (MFP) having the printing and copying functions are connected to a network.

Such a system is provided with a control unit (monitor server) to control the load by the data transferred through the network. This control unit performs the following operations, for example, to disperse the load. When image data is transmitted from a certain PC to an MFP but the MFP is busy, the control unit transfers the data to another MFP.

As the above-mentioned system needs a control unit to disperse the load, the system cost is increased by the control unit. Further, as the control unit executes centralized load control, it becomes impossible to disperse the load from the MFP connected to the network.

Therefore, there is need for an image processing apparatus, which requires no control unit to disperse the load on the network, obtains independently necessary information from other units connected to the network, and disperses the load based on the obtained information.

### BRIEF SUMMARY OF THE INVENTION

According to an aspect of the present invention, there is provided an image processing apparatus which receives print data from a print data source through a connection section connected to a network, interprets the language of the received print data and develop the data, and generates a first image data from the developed print data. The apparatus reads an image from a copy document and generates a second image data. The apparatus compresses at least one image data of the first and second image data, and stores it temporarily. The apparatus transfers the stored compressed data to an image forming unit connected to the network.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a schematic block diagram showing a configuration of a whole system of a network and MFP in an embodiment of the present invention;

FIG. 2 is a diagram showing the flow of data;

FIG. 3A is a flowchart showing the first half of image data transfer process;

FIG. 3B is a flowchart showing the latter half of image data transfer process; and

FIG. 4 is a flowchart showing a process of calculating the transfer number of prints or copies.

### DETAILED DESCRIPTION OF THE INVENTION

An embodiment of the present invention will be described hereinafter with reference to the accompanied drawings. Description will be given to the case where the present invention is applied to a multifunction peripherals (MFP) 1.

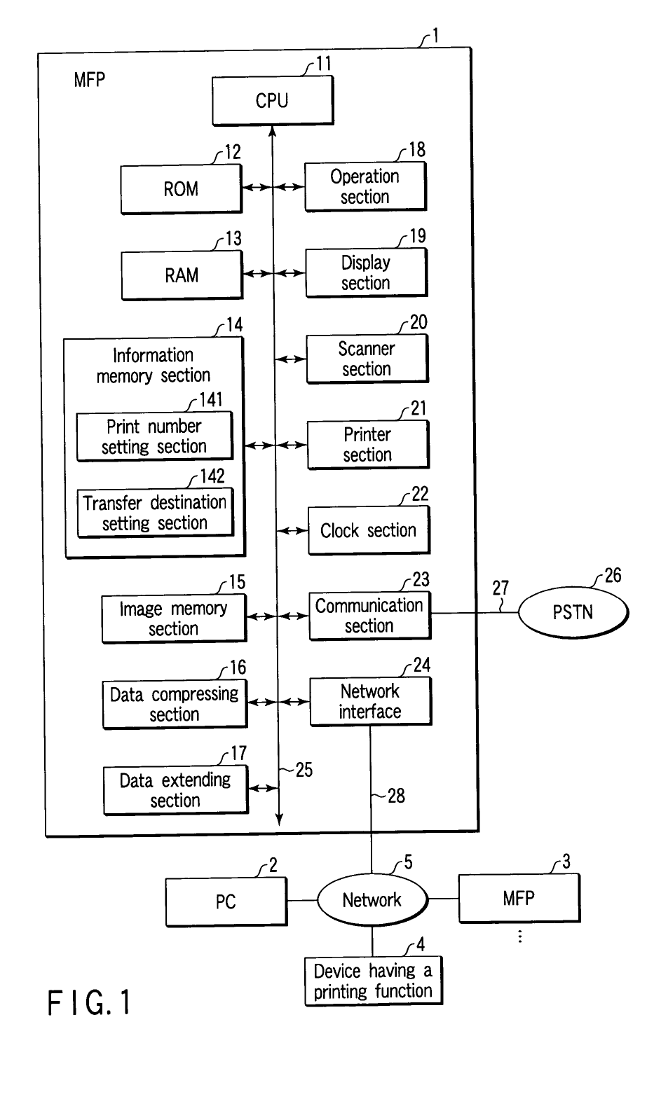

FIG. 1 shows a system in which MFP 1 is communicably connected via a network 5 to a PC 2, another plurality of MFP 3 and a device 4 having a printing function.

The MFP 1 roughly comprises a CPU 11, a ROM 12, a RAM 13, an information memory section 14, an image memory section 15, a data compressing section 16, a data extending section 17, an operation section 18, a display section 19, a scanner section 20 as an image reader section, a printer section 21, a clock section 22, a communication section 23 and a network interface 24. The CPU 11 is connected via a bus line 25 to the ROM 12, RAM 13, information memory section 14, image memory section 15, data compressing section 16, data extending section 17, operation section 18, display section 19, scanner section 20, printer section 21, clock section 22, communication section 23 and interface 24 as a network connection section.

The CPU 11 realizes the function as MFP 1 by executing the control operation to generally control each section based on the control program stored in the ROM 12. The ROM 12 stores the control program of CPU 11. The RAM 13 is used by the CPU 11 as a work area to execute various operations.

The information memory section 14 consists of a flash memory, for example. The information memory section 14 includes a print number setting section 141 and a transfer destination setting section 142. The print number setting section 141 stores the number of prints used to decide whether the number of copies or prints is high or not. The transfer destination setting section 142 stores the automatic transfer data to decide whether to automatically transfer the temporarily held image data when an error occurs in the MFP 1, and stores the transfer destination unit when the automatic transfer is set. The image memory section 15 consists of a large capacity DRAM or a hard disk drive, for example. The image memory section 15 temporarily stores the received image data and the image data waiting for transmission.

The data compressing section 16 encodes the image data to compress the redundancy. The data extending section 17 extends the image data encoded to compress the redundancy. The scanner section 20 reads the document sent from a not-shown automatic document feeder (ADF). The scanner section 20 also generates the image data of the document from the read image. The printer section 21 forms an image on paper based on the image data generated by the scanner section 20 or the image indicated by the print data received through the network interface 24.

The communication section 23 consists of a not-shown modem, an NCU, a telephone control section and a line signal detection section. The communication section 23 is connected with a PSTN subscriber telephone line 27 contained in a PSTN 26. The network interface 24 is connected to the network 5 via a line 28. Therefore, the MFP 1 can communicate with the PC 2, a plurality of MFP 3 and the device 4 having the printing function.

The operation section 18 accepts various user commands input to the CPU 11. The display section 19 displays various information to be notified to the user under the control of CPU 11. By operating the operation section 18, the user can set the MFP 1 so that it executes the following functions. The user can set various colors representing of copy functions, such as full-color copy function, monochrome/full-color function, three-color copy function and twin-color copy function. The user can set the magnification/reduction rate, printable paper size and type, number of prints, double-side printing function, sorting function, stapling function, middle-stitching function and Nin1 function. The double-side printing function, sorting function and stapling function cannot be used if the respective optional units are not provided. Further, by operating the operation section 18, the user can set the number of prints stored in the information memory section 14, the automatic transfer and the transfer destination unit. The clock section 22 always ticks and output the current time information showing the current time, and counts the preset time under the control of CPU 11.

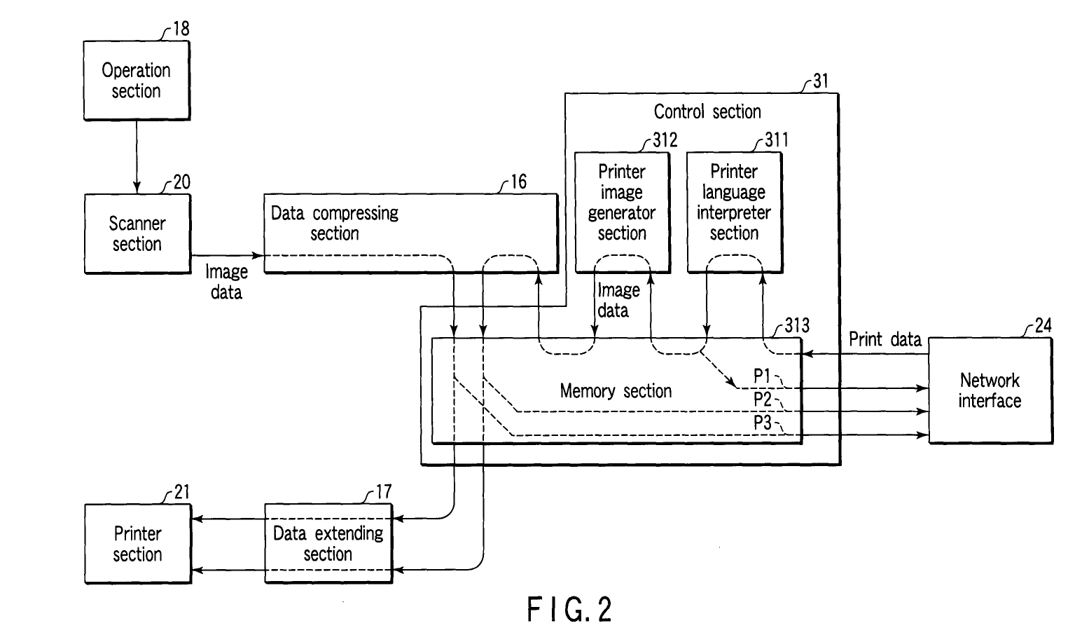

Description will now be given of the copy function of MFP 1 configured as above described, i.e., the flow of the image data when realizing the printing function for the print data received through the network 5, with reference to FIG. 2.

A control section 31 in FIG. 2 comprises a CPU 11, a ROM 12, a RAM 13, an information memory section 14 and an image memory section 15. The control section 31 is functionally composed of a printer language interpreter section 311, a printer image generator section 312 and a memory section 313.

The printer language interrupter section 311 interprets the postscript (PS) language from the print data received through the network interface 24, and develops the print data.

The printer image generator section 312 generates the image data from the data developed by the printer language interpreter section 311.

The memory section 313 temporarily stores the data processed by the printer language interpreter section 311, printer image generator section 312 and data compressing section 16.

First, description will be given of the case where the MFP 1 prints the print data received through the network 5. In the MFP 1, for example, the print data sent from the PC 2 through the network 5 by using TCP/IP protocol, is received as a print request. The print data is once stored in the memory section 313, and registered in the queue for interpretation of the printer language.

The print data coming to the turn for processing is developed in the postscript (PS) language by the printer language interpreter section 311. And, the data is once stored in the memory section 313, and image data is generated through the printer image generator section 312. Next, the image data is compressed by the data compressing section 16, stored temporarily in the memory section 313, and registered in the spool queue for printing. At this time, the data relating to the printing method included in the print data is also compressed and saved together with the image data. The printing method data includes the information about how to output the image data in the printer, such as double-side printing, stapling, number of prints, sorting and specification of paper.

Next, description will be given of the flow of image data when MFP 1 performs copying. When the copy function is selected by the user by operating the operation section 18, a document image is taken by the scanner section 20 based on the copying method specified by the user, and image data is generated. This image data is compressed through the data compressing section 16. At this time, the set data necessary for printing out of the copying method set by the user is compressed as a printing method data and saved in the memory section 313 together with the image data, and registered in the spool queue for printing.

Paths P1, P2 and P3 shown in the drawing conceptually show the flow of image data when it is transferred by the image data transfer process. This is described later.

The paths P1 and P2 show the flow of data when transferring the print data when printing is executed. The print data is transferred through one of the transfer paths P1 and P2. The path P1 shows the flow of transferring the print data, when the print data developed by the printer language interpreter section 311 is once stored in the memory section 313. The path P2 shows the flow of transferring the print data, when the print data developed by the printer image generator section 312 is compressed by the data compressing section 16 and once stored in the memory section 313. The path P3 shows the flow of image data when the image data read and generated by the scanner section 20 is compressed by the data compressing section 16 and temporarily stored in the memory section 313. When the system is configured to transfer the image data as in the path P2, the data format becomes the same as the data read from the scanner. Therefore, transfer of the data common to both printer and copier is possible, and the cost is reduced.

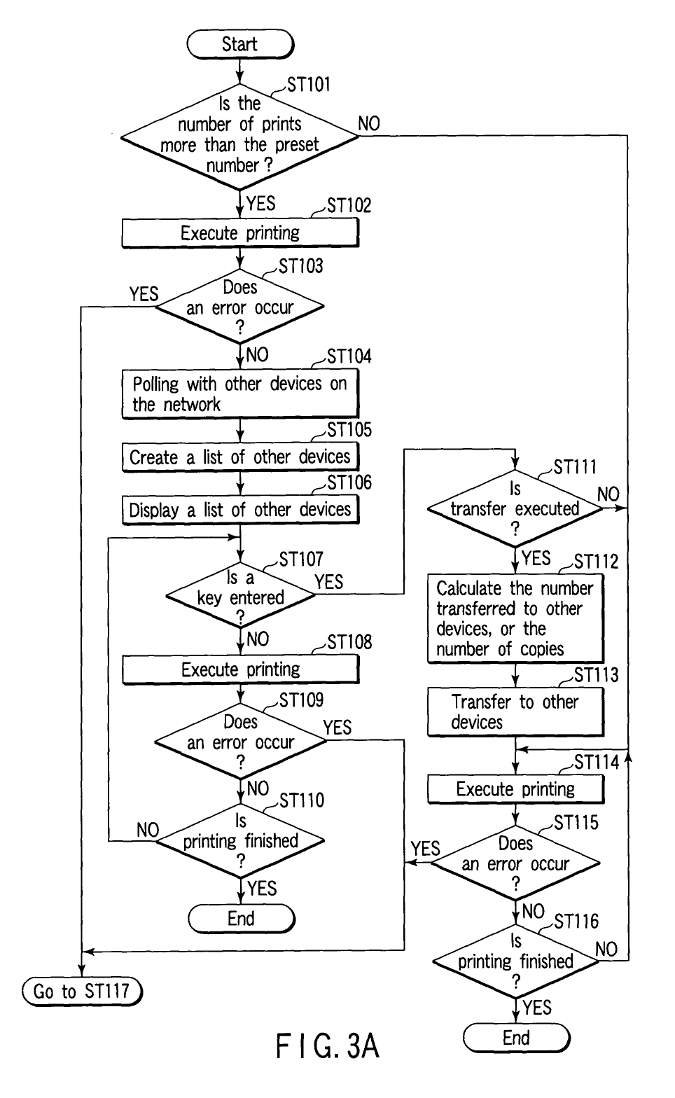

Next, description will be given of the flow of processing executed by the CPU 11 when printing or copying, with reference to FIG. 3A and FIG. 3B. In this description, the print data transfer path is the above-mentioned path P2.

In step ST101, the CPU 11 decides whether the number of prints of the image data coming up to the turn of copying or printing is more or less than the number of prints stored in the print number setting section 141 (a decision section). The process advances to step ST102 when YES in this decision, and advances to step ST114 if NO. In step ST102, the CPU 11 extends the image data coming up to the turn for processing by the data extending section 17, and operates the printer section 21 to execute printing.

Next, in step ST103, the CPU 11 decides whether an error is detected or not (a detection section). The error mentioned here means the state where printing is interrupted. For example, the error includes paper exhausted, toner exhausted or paper jam. If a unit which restricts the user is installed, the error includes detection of failure in inserting a control key or a control card. Further, the error includes the case where an operator error such as failure in inputting an ID code occurs, or the case where a serviceman error such as a defect occurring in MFP 1 and maintenance by a serviceman is necessary. The process advances to step ST104 when YES in this step, and advances to step ST117 if NO.

In step ST104, the CPU 11 makes polling with a plurality of MFP 3 and the device 4 having the printing function which are connected to the network 5. By the polling, the CPU 11 obtains the information about the operating status and error status, information about optional units, information about the installation places and information about the processing capacity of the units connected to the network 5 (an information obtaining section).

In step ST105, the CPU 11 creates a list of units capable of transferring the image data, based on the information obtained by polling (an information creating section). Considering the finishing capacity of a transfer destination unit, based on the information about the obtained optional unit, a unit which can correctly execute the printing method included in the print request is selected as a unit capable of transferring the image data. This enables the user to select only the transfer destination which can print as specified by the print/copy request. The user can also get the desired finishing output result, when transferring the image data. The above list can be made including the image data transferable unit and the information about the operating status and installation place of that unit. This permits the user to determine the state of the transfer destination unit and the distance to the transfer destination unit which cannot be automatically determined. Further, even if the image data transfer destination unit is not installed nearby, the user can transfer the print data to a desired unit. It is also possible to make the transfer destination list based on the information about the obtained processing capacity, so that the destination units are displayed on the display section 19 in the order of the image data processing speed. Further, It is also possible to make the transfer destination list based on the obtained information about the optional unit, so that the destination units are displayed on the display section 19 separately in a group of units meeting the finishing capacity specified by the print/copy request and a group of the other units. This makes it possible to enforce the unit, which does not match the finishing capacity, to output the data when urgent printing or copying is required. If the information about the processing capacity and the information about the finishing capacity are displayed together, the user can output data by changing the printing method by operating the operation section 18, based on the display. The user can previously set what type of list to make, by operating the operation section 18.

In step ST106, the CPU 11 displays the created list of units together with the operating status, error status, finishing capacity, processing capacity and installation place of each unit, on the display section 19 based on the user's setting.

In step ST107, the CPU 11 determines whether the key input to execute transfer is received from the operation section 18. The process advances to step ST111 when YES, and the process advances to step ST108 if NO.

In step ST108, the CPU 11 continues printing the image data. In step ST109, the CPU 11 determines whether the occurrence of error is detected or not (another detection section). The process advances to step ST117 when YES, and the process advances to step ST 110 if NO. In step ST110, the CPU 11 determines whether the image data printing ends or not. The process is finished when YES, and the process goes back to step ST 107 if NO. Namely, the CPU 11 waits for the key input to determine whether to execute transfer, from the operation section 18, and watches occurrence of error, until the printing is finished.

In step ST111, the CPU 11 determines whether the received key input command is to execute transfer of the image data or not. For example, the CPU 11 accepts the input of YES for the transfer and specification of the transfer destination, or determines whether the input of NO for the transfer is accepted. The process advances to step ST112 when YES, and the process advances to ST 114 if NO.

In step ST112, the CPU 11 calculates the number of prints or copies to transfer to another unit (a calculation section). The calculating operation will be explained later. In step ST113, the CPU 11 transfers the image data corresponding to the calculated number of prints or copies, to the specified unit through the network 5 (a transfer section).

In step ST114, the CPU 11 continues printing the image data. In step ST115, the CPU 11 decides whether the occurrence of error is detected or not (a still another detection section). The process advances to step ST117 when YES, and the process advances to step ST116 if NO. In step ST116, the CPU 11 decides whether the image data printing is finished or not. The process is finished when YES, and the process goes back to step ST114 if NO.

In step ST117, the CPU 11 displays the message corresponding to the detected error on the display section 19. As above described, when an error occurs in the MFP 1 used by the user, the user can confirm the type of the error on the display section 19. This enables the user to determine not to transfer the image data. This is useful when the occurred error can be immediately corrected or when the destination unit is installed far away, for example.

In step ST118, the CPU 11 make polling with the units connected to the network 5. In step ST119, the CPU 11 creates a list of the units connected to the network 5, based on the result of polling. In step ST120, the CPU 11 displays the created list on the display section 19. As steps ST118 to ST120 are the same as steps ST104 to ST106 described above, the detail explanation will be omitted.

In step ST121, the CPU 11 decides whether automatic transfer is set, according to the setting of the transfer destination setting section 142. The process advances to step ST122 when NO, and the step advances to step ST125 if YES.

In step ST122, the CPU 11 operates the clock section 22 and starts counting the predetermined time, and decides whether specification of the image data transfer unit is accepted from the list displayed on the display section 19. The CPU 11 waits for the user's specification of a destination unit, until the preset time counted by the clock section 22 expires. In step ST123, the CPU 11 decides whether the preset time expires or not, that is, timeout or not (a timeout decision section). When timeout is decided, the process advances to step ST124. In step 124, the CPU 11 automatically sets the unit of the highest processing speed, for example, as an image data transfer destination. Then, the process advances to step ST125. As above described, the automatic image data transfer is enabled by the timeout upon occurrence of error, thereby the operation is automated when the user is absent, preventing a time loss caused by printing after time passes.

In step ST125, the CPU 11 transfers the image data not yet printed to the destination unit set by the transfer destination setting section 142 or the destination unit specified by the user in step ST122 (a transfer section). As above described, when occurrence of an error is detected and automatic transfer is set, the MFP does not transfer the data unless the user's transfer command is accepted, and the network 5 is not given a load. And, in step ST126, the CPU 11 displays the name of the image data transferred unit and the end of transfer on the display section 19. The process is completed by this step.

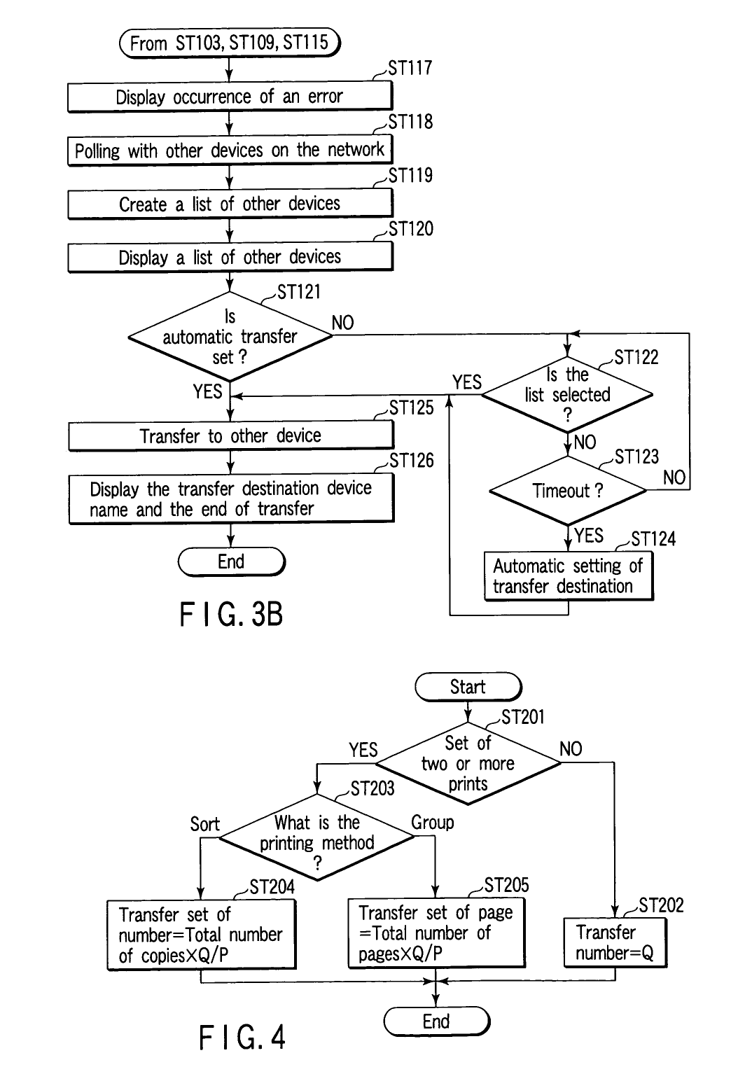

Description will now be given to the processing executed by the CPU 11 in step ST112, that is, calculation of the number of transfer prints (i.e., transfer data) with reference to FIG. 4.

In the description, P denotes the residual number of prints, Q denotes the number of substitutive prints, N denotes the printing capacity of MFP1, M denotes the printing capacity of other units, and T denotes the time required to start printing in other units. An equation (P−Q)/N=Q/M+T is established. According to this equation, the optimum number of substitutive prints in other units is expressed by an equation Q=(MP−MNP)/(M+N)

In step ST201, the CPU 11 decides whether the image data is to be printed in set of two or more. The process advances to step ST202 when NO, and the process advances to step ST203 if YES. In step ST202, the CPU 11 calculates the optimum number of substitutive prints which can be obtained from the above-mentioned equation.

In step ST203, the CPU 11 determines whether the printing method is sort or group, according to the data about the printing method supplied with the image data. The step advances to step ST204 when the method is sort, and the process advances to step ST205 if group.

In step ST204, the CPU 11 calculates the transfer set of number. Assuming the number of prints to be a total number, the transfer set of number can be calculated by the equation: Transfer set of number=Total copy number×Q/P. In the case of sort printing, post-processing such as punching and stapling may be included, and the data is to be transferred to other units by each number of copies. At this time, the number of pages is not necessarily divided and needs to be rounded. Round off of the number of pages is performed when the printing capacity of the destination unit is greater than that of the source unit, and reduction is performed when it is equivalent or lower.

In step ST205, the CPU 11 calculates the transfer set of pages. Using the total page number included in the print data, the transfer set of pages can be calculated by the equation: Transfer set of pages=Total page number×Q/P. In the case of group printing, a plurality of number is printed on each page, and the page number is rounded to prevent the same page from being divided by two MFPS. Rounding is the same as that in step ST204.

Therefore, when an error occurs or a request to print/copy a number more than the predetermined number occurs, the MFP1 makes polling for the MFP3 and the device 4 having the printing function connected to the network 5, and collects the information about each unit. The MFPl can display the transfer destination unit together with the operating status, error status and available functions of each unit on the display section 19 of MFP1. This enables the user to select the data transfer destination unit, and the user can transfer the image data based on his/her decision. This permits the MFP1 to execute substitutive printing in other units.

As above described, the MFPl does not require a control unit to transfer image data, and the system cost is lowered. Further, the MFP1 used by the user accepts the user's decision whether to transfer or not, improving the user's convenience.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a connection section which connects a network to which an image forming unit and a print data source are connected;
a printer language interpreter section which interprets the language of the print data received from the print data source, and develops the data;
a printer image generator section which generates a first image data from the developed print data;
an image reader section which reads an image from a document to be copied and generates a second image data;
a data compressing section which compresses at least one of the first and second image data;
a memory section which temporarily stores the compressed data; and
a transfer section which transfers the stored data to the image forming unit through the connection section.

2. The image processing apparatus according to claim 1, further comprising a detection section which detects occurrence of an error during printing based on the compressed data;
an information obtaining section which obtains information about other image forming units through the connection section when the detection section detects an error;
an information creating section which creates information to be notified to a user, based on the information about the image forming unit obtained by the information obtaining section;
a display section which displays the information created by the information creating section; and
an operation section which accepts a command to execute transfer of the compressed data and specification of a destination image forming unit, based on the information displayed on the display section; wherein
the transfer section transfers the non-printed compressed data stored in the memory section to the image forming unit specified by the operation section.

3. The image processing apparatus according to claim 2, further comprising a timeout decision section which measures a predetermined time and decides timeout after displaying the information created by the information creating section on the display section; wherein
when the timeout decision section decides timeout, the transfer section automatically sets a transfer destination, and transfers the non-printed compressed data in the print output section to the destination.

4. The image processing apparatus according to claim 2, wherein the information about the image forming unit obtained by the information obtaining section is at least one of the information about operating status, error status and available functions.

5. The image processing apparatus according to claim 4, wherein the information obtaining section further obtains information about an optional unit; and the information creating section creates, from the information obtained by the information obtaining section, only the information about an image forming unit which is printable by the printing method specified in the compressed data, as information to be displayed on the display section.

6. The image processing apparatus according to claim 4, wherein the information obtaining section further obtains the information about an optional unit; and the information creating section creates, from the information obtained by the information obtaining section, the information about an image forming unit which is printable by the image data printing method and the information about an image forming unit which is not printable, as information to be separately displayed on the display section.

7. The image processing apparatus according to claim 4, wherein the information obtaining section further obtains the information about the installation place of an image forming unit.

8. The image processing apparatus according to claim 4, wherein the information obtaining section further obtains the information about the processing capacity of an image forming unit.

9. The image processing apparatus according to claim 1, further comprising:
a decision section which decides by the stored compressed data whether the number of prints is more or less than the preset number of prints;
an information obtaining section which obtains information about the image forming unit through the connection section, when the decision section decides that the number of prints of stored compressed data is more than the preset number of prints;
an information creating section which creates information to be notified to a user, based on the information about the image forming unit obtained by the information obtaining section;
a display section which displays the information created by the information creating section;
an operation section which accepts a command to execute transfer of the data compressed by the compressing section and specification of a destination image forming unit, based on the information displayed on the display section; and
a calculation section which calculates data to be transferred from the stored compressed data, based on the information obtained by the information obtaining section, when the operation section accepts specification of a destination image forming unit; wherein
the transfer section transfers the quantity of image data calculated by the calculation section to the destination accepted by the operation section.

10. The image processing apparatus according to claim 9, wherein the information about the image forming unit obtained by the information obtaining section is at least one of the information about operating status and error status.

11. The image processing apparatus according to claim 10, wherein the information obtaining section further obtains information about an optional unit, and the information creating section creates, from the information obtained by the information obtaining section, only the information about an image forming unit which is printable by the printing method specified in the compressed data, as information to be displayed on the display section.

12. The image processing apparatus according to claim 10, wherein the information obtaining section further obtains the information about an optional unit; and the information creating section creates, from the information obtained by the information obtaining section, the information about an image forming unit which is printable by the image data printing method and the information about an image forming unit which is not printable, as information to be separately displayed on the display section.

13. The image processing apparatus according to claim 10, wherein the information obtaining section further obtains the information about the installation place of an image forming unit.

14. The image processing apparatus according to claim 10, wherein the information obtaining section further obtains the information about the processing capacity of an image forming unit.

15. An image processing method comprising:
receiving print data from a print data source through a network;
interrupting the language of the received print data, and developing the data;
creating image data from the developed print data;
reading an image from a document, and creating image data;
compressing one of the created image data;
storing temporarily the compressed data; and
transferring the stored compressed data to an image forming unit connected to the network.

16. The image processing method according to claim 15, further comprising:
detecting occurrence of an error to perform printing;
obtaining information about an image forming unit connected to the network, when occurrence of an error is detected;
creating information to be notified to a user, based on the obtained information;
displaying the created information; and
accepting a command to execute transfer of the non-printed compressed data and specification of a destination image forming unit, based on the display; wherein
the non-printed compressed data is transferred to the specified image forming unit.

17. The image processing method according to claim 16, wherein the information about the obtained image forming unit is at least one of the information about operating status, error status and available function.

18. The image processing method according to claim 15, further comprising:
deciding whether the number of prints of stored compressed data is more or less than the preset number of prints;
obtaining information about an image forming unit connected to a network, when the decision is more;
creating information to be notified to a user based on the obtained information;
displaying the created information;
accepting a command to execute transfer of the compressed data and specification of a destination image forming unit, based on the display; and
calculating the quantity of transferred image data from the quantity of stored compressed data, based on the obtained information, when specifications of a destination image forming unit are accepted; wherein
the calculated compressed data is transferred to the specified image forming unit.

19. The image processing method according to claim 18, wherein the obtained image about the image forming unit is at least one of the information about operating status, error status and available functions.
